(19) United States
(12) Patent Application Publication
(10) Pub. No.: US 2013/0183571 A1
(43) Pub. Date: Jul. 18, 2013

(54) BATTERY PACK AND VEHICLE INCLUDING THE SAME

(71) Applicants: Yutaka Miyazaki, Miki-shi (JP); Shingo Ochi, Takasago-shi (JP); Atsushi Fujita, Shikokuchuo-shi (JP)

(72) Inventors: Yutaka Miyazaki, Miki-shi (JP); Shingo Ochi, Takasago-shi (JP); Atsushi Fujita, Shikokuchuo-shi (JP)

(73) Assignee: SANYO ELECTRIC CO., LTD., Moriguchi-shi, Osaka (JP)

(21) Appl. No.: 13/822,885

(22) PCT Filed: Sep. 27, 2011
(86) PCT No.: PCT/JP2011/072128

§ 371 Date: Apr. 3, 2013

(30) Foreign Application Priority Data
Sep. 30, 2010 (JP) 2010-223163

(51) Int. Cl. H01M 2/20

(52) U.S. Cl. CPC H01M 2/20
USPC 429/156

(57) ABSTRACT

A battery pack includes a battery assembly constructed of rectangular battery cells that are arranged side by side. End plates are arranged on the end surface of the assembly. Metal bind bars securely hold the assembly and the plates. Each bar includes bent parts that are formed by bending the both bar end parts toward a common direction. The bar is formed in a substantially rectangular U shape as viewed from the bar edge side The bent parts on the both bar ends are coupled to the plates so that the assembly is interposed and secured between the plates. A bent-part-side engagement structure is formed in a coupling area of the bent part of the bar. An end-plate-side engagement structure is positioned in the plate to face the bent part. When the bent-part-side and end-plate-side engagement structures engage with each other, the bar is fastened to the plates.

### BACKGROUND OF THE INVENTION

1. Technical Field

The present invention relates to a battery pack including a plurality of rectangular battery cells that are arranged side by side with separators being sandwiched between the battery cells, and a vehicle using this battery pack. The present invention relates more particularly to a battery pack that is installed on an electric vehicle such as hybrid car and electric car and suitable as a power supply for supplying electric power to an electric motor for driving the vehicle, and a vehicle using this battery pack.

2. Description of the Related Art

A number of battery cells are serially connected to each other to increase the output voltage whereby increasing the output electric power of a vehicle battery pack. Battery packs have been developed which are constructed of a number of rectangular battery cells that are arranged side by side whereby increasing the volumetric charge densities of the battery packs (see Japanese Patent Laid-Open Publication Nos. JP 2008-282,582 A and JP 2008-53,019 A).

In the battery pack disclosed in JP 2008-282,582 A, rectangular battery cells 91 are arranged side by side and secured by bind bars 94 with electrically insulating separators 92 being sandwiched between the battery cells, as shown in FIG. 15. The bind bar 94 is formed of a strip-shaped metal plate, and includes bent parts 94X that are formed by bending both end parts of the strip-shaped metal plate so that the bind bar is formed in a rectangular U shape as viewed from the bar edge side. A battery assembly 95 is constructed of the side-by-side-arranged rectangular battery cells 91 and end plates 93 that are arranged on both end surfaces of the battery assembly. When the bent parts 94X of the bind bar 94 are fastened to the exterior surfaces of the end plates 93 by screws, the rectangular battery cells are interposed and held between the end plates 93.

3. Technical Problem

As discussed above, in order to fasten the bind bars to the end plates, in the known battery pack, screws 96 pass through screw holes 94a that are formed in the bent parts 94X, and are screwed into the end plates, as shown in FIG. 15. However, in this approach, there is a problem that the screwing process requires time and effort. In particular, as the number of bind bars increases, the number of screws to be screwed increases, which in turn increases man-hour or machine-hour in assembly of the battery pack. In particular, in the case where the battery packs are used in vehicles, the battery packs are constantly subject to vibrations and shocks. For this reason, the bind bars are necessarily firmly and reliably fastened. In addition, as a general trend, the number of the side-by-side-arranged rectangular battery cells increases to provide higher power. As the number of the battery cells increases, it will be more difficult to securely hold the battery cells by the bind bars. Correspondingly, high strength and reliability are required for the process for securely holding the battery cells by the bind bars. To address this, the screwing torque is controlled. As a result, there is a problem that this torque control is a burden. Also, a battery pack has been proposed which fastens the bind bar to the end plates by riveting instead of screwing (see JP 2008-53,019 A). In this approach, the riveting also requires time and effort. This approach has poor workability similar to the screwing.

The present invention is aimed at solving the above problem, and its main object is to provide a battery pack including bind bars that can be easily and quickly fastened without sacrificing reliability, and a vehicle using this battery pack.

### SUMMARY OF THE INVENTION

To achieve the above object, a battery pack according to a first aspect of the present invention includes a battery assembly, a pair of end plates, and a plurality of metal bind bars. The battery assembly includes a plurality of rectangular battery cells that are arranged side by side. The end plates are arranged on the side-by-side arrangement directional end surfaces of the battery assembly. The metal bind bars couple the end plates, which are arranged on the end surfaces of the battery assembly, to each other. Each of the bind bars includes bent parts that are formed by bending the both end parts of the bind bar toward a common direction. The bind bar is formed in a substantially rectangular U shape as viewed from the bar edge side by forming the bent parts by bending the both end parts of the bind bar. The bent parts on the both ends of the bind bar are coupled to the end plates so that the battery assembly is interposed and secured between the end plates. The bent part includes a bent-part-side engagement structure in a coupling area of the bent part to be coupled to the end plate. The end plate includes an end-plate-side engagement structure that is positioned so as to face the bent part. The end plates are securely held by the bind bars when the bent-part-side engagement structures of the bind bars engage with the end-plate-side engagement structures of the end plates.

According to this construction, the bind bars can be easily and quickly fastened by engagement of bent-part-side engagement structure with the end-plate-side engagement structure without screws for fastening the bind bar to the end plate. In addition, since the substantially rectangular U-shaped bent parts can press the end plates on the both end surfaces of the battery assembly in the side-by-side arrangement direction of the battery cells when the end plates and the battery assembly are interposed between the bent parts, even if the battery cells expands, opposite forces can be applied to the end plates by the reaction of bent parts so that the battery assembly can be more firmly held. Therefore, there is an advantage that the reliability of the battery pack can be high.

In a battery pack according to a second aspect of the present invention, the bind bar can be constructed so that the bent parts on both ends of the bind bar can be in press contact with the outside surfaces of the end plates.

According to this construction, when the bent parts of the bind bar are brought in contact with the outside surfaces of the end plates, the bent-part-side engagement structures can easily and reliably engage with the end-plate-side engagement structures so that the bind bar can be fastened to the end plates.

In a battery pack according to a third aspect of the present invention, the bent-part-side engagement structure can be a slit that is formed in a rectangular shape, and the end-plate-side engagement structure can be an engagement protrusion that can be inserted into the slit.

According to this construction, when the engagement protrusion of the end plate is inserted into the slit of the bind bar, the bind bar can hold the battery assembly. Therefore, there is an advantage that the battery pack can be easily and quickly assembled. In addition, the simple engagement structures can prevent the bind bar from dropping off even under vibrations and shocks. As a result, the end plates and the battery assembly can be stably secured.

In a battery pack according to a fourth aspect of the present invention, the end plate can include a metal plate. The metal plate is partially bent so that the engagement protrusion is formed.

According to this construction, the end plate can be reinforced by the metal plate. In addition to this, since the metal plate is partially bent so that the engagement protrusion is formed, although the engagement protrusion can be simply formed, the bind bar can be firmly coupled to the end plate.

In a battery pack according to a fifth aspect of the present invention, an inclined surface can be formed on one side of the engagement protrusion.

According to this construction, there is an advantage that the engagement protrusion can be easily inserted into the slit, which in turn can provide easy assembling.

In a battery pack according to a sixth aspect of the present invention, the end plate can include an inclined surface on a side part of the outside surface that is located on the engagement side where the substantially rectangular U-shaped opening of the bind bar is coupled. The inclined surface descends toward the substantially rectangular U-shaped opening.

According to this construction, when the bind bar engages with the end plates and the battery assembly, the end plates and the battery assembly can be easily inserted into the substantially rectangular U-shaped opening of the bind bar. Therefore, there is an advantage that the battery pack can be easily assembled.

In a battery pack according to a seventh aspect of the present invention, the end plate can include a main plate, and a metal plate. The main plate is formed of plastic. The metal plate is arranged on the outside surface of the main plate. The metal plate is coupled to the main plate and arranged in a predetermined position on the main plate by a positioning mechanism. The bent part of the bind bar is arranged in a predetermined position on the end plate by the positioning mechanism.

According to this construction, the main plate formed of plastic can be reinforced by the metal plate, while the main plate and the metal plate can be coupled to each other in place by the positioning mechanism. In addition to this, the bent part of the bind bar can be arranged in place on the end plate by the positioning mechanism.

In a battery pack according to an eighth aspect of the present invention, the positioning mechanism can include a positioning protruding part, a positioning hole, and a coupling hole. The positioning protruding part is arranged on the main plate. The positioning hole is arranged in the metal plate, and can receive the positioning protruding part. The coupling hole is arranged in the bent parts of the bind bars, and can receive the positioning protruding part. The positioning protruding part of the main plate is inserted into the positioning hole of the metal plate so that the metal plate is coupled to the main plate, and arranged in the predetermined position on the main plate. The positioning protruding part that is inserted into the metal plate is inserted into the coupling hole of the bent part so that the bind bar is arranged in the predetermined position on the end plate.

According to this construction, this simple positioning mechanism can position the metal plate in the predetermined position on the main plate, and position the bent part of the bind bar in the predetermined position on the end plate when the main plate, metal plate and the bent part are coupled to each other.

In a battery pack according to a ninth aspect of the present invention, the bind bars can be arranged on the side surfaces of the battery assembly.

According to this construction, since the bind bars securely hold the both side surfaces of the battery assembly, it is possible prevent that the bind bar interferes with electrode terminals on the upper surface of the battery cells. In addition to this, a cooling plate can be arranged on the battery cell lower surfaces without interference with the bind bars.

In a battery pack according to a tenth aspect of the present invention, a plurality of strips can be arranged as the bind bars and spaced away from each other in the vertical direction on the side surface of the battery assembly.

According to this construction, since a plurality of strips form divided parts of the bind bar so that the central part of the side surface of the battery assembly can be exposed, cooling air flows through parts between the battery cells and cool the battery cells.

In a battery pack according to an eleventh aspect of the present invention, the height of the bent parts, which are located on the both ends of the bind bar, can be larger than the strip-shaped main part of the bind bar.

According to this construction, the engagement part of the bind bar can be large. Accordingly, the mechanical strength of the engagement part can be increased. Therefore, the end plates and the battery assembly can be more reliably secured.

In a battery pack according to a twelfth aspect of the present invention, upper and lower bar portions and as the bind bars cover the upper and lower parts of the side surface of the battery assembly. The both ends of the upper bar portion are coupled to the both ends of the lower bar portion so that the bind bar has an opening that exposes the central part of the side surface of the battery assembly.

According to this construction, since the side surface of the battery assembly can be exposed, cooling air flows through parts between the battery cells and cool the battery cells.

In a battery pack according to a thirteenth aspect of the present invention, the bind bar can be dimensioned to cover the side surface of the battery assembly. The battery assembly can be placed on the upper surface of a cooling plate. The cooling plate can include a coolant pipe, and be thermally connected to the bottom surfaces of the rectangular battery cells.

According to this construction, although the bind bar can be large and have high mechanical strength, the battery assembly can be cooled not from the side surfaces but from the bottom surface, and as a result the battery cell cooling performance is not reduced.

A battery vehicle according to a fourteenth aspect of the present invention can include the battery pack according to any of first to thirteenth aspect.

### BRIEF DESCRIPTION OF THE DRAWINGS

FIG. 1: Perspective view showing a power supply device including a battery pack according to a first embodiment of the present invention.

FIG. 2: Perspective view showing the power supply device shown in FIG. 1 with an upper case being removed.

FIG. 3: Perspective view showing the battery pack according to the first embodiment of the present invention.

FIG. 4: Exploded perspective view showing the battery pack shown in FIG. 3 with bind bars being removed.

FIG. 5: Exploded perspective view showing the battery pack shown in FIG. 3.

FIG. 6: Enlarged perspective view showing coupling areas of the bind bars of the battery pack shown in FIG. 3.

FIG. 7: Enlarged cross-sectional view showing the battery pack shown in FIG. 6 taken along the line VII-VII.

FIG. 8: Enlarged cross-sectional view showing the battery pack shown in FIG. 3 taken along the line VIII-VIII.

FIG. 9: Exploded perspective view showing the battery pack according to a second embodiment of the present invention.

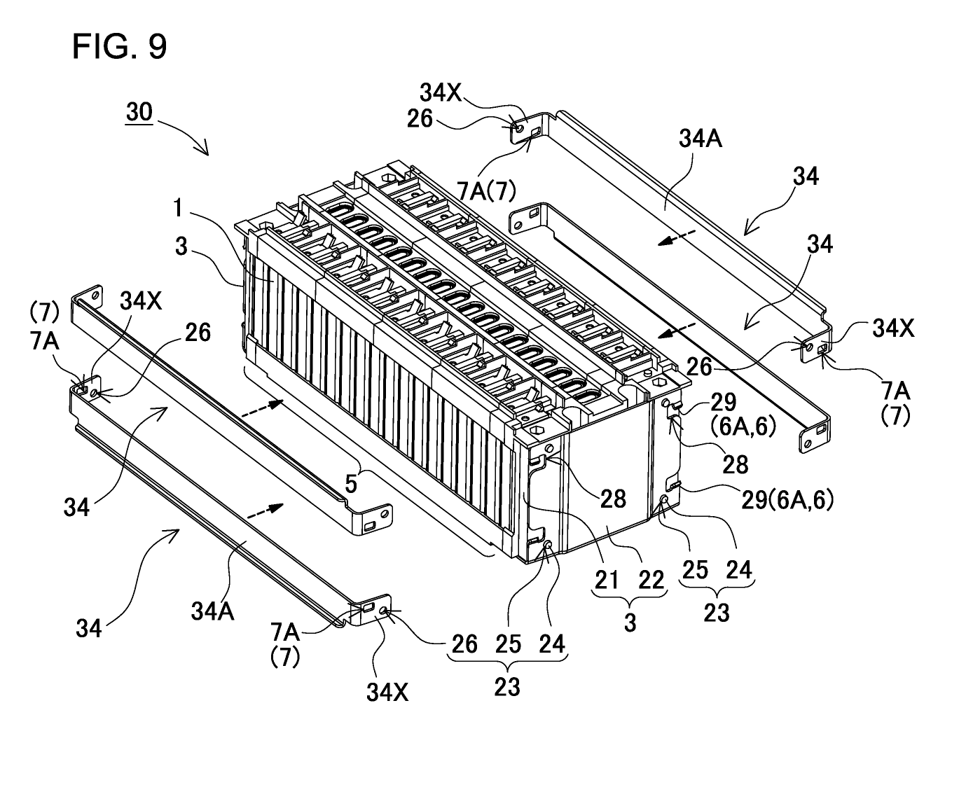

FIG. 10: Exploded perspective view showing the battery pack according to a third embodiment of the present invention.

FIG. 11: Exploded perspective view showing the battery pack according to a fourth embodiment of the present invention.

FIG. 12: Exploded cross-sectional view showing coupling structures of the bind bars and an end plate of the battery pack according to a modified embodiment of the present invention.

FIG. 13: Block diagram showing an exemplary hybrid car that is driven by an internal-combustion engine and an electric motor, and includes the power supply device.

FIG. 14: Block diagram showing an exemplary electric car that is driven only by an electric motor, and includes the power supply device.

FIG. 15: Exploded perspective view showing a known battery pack.

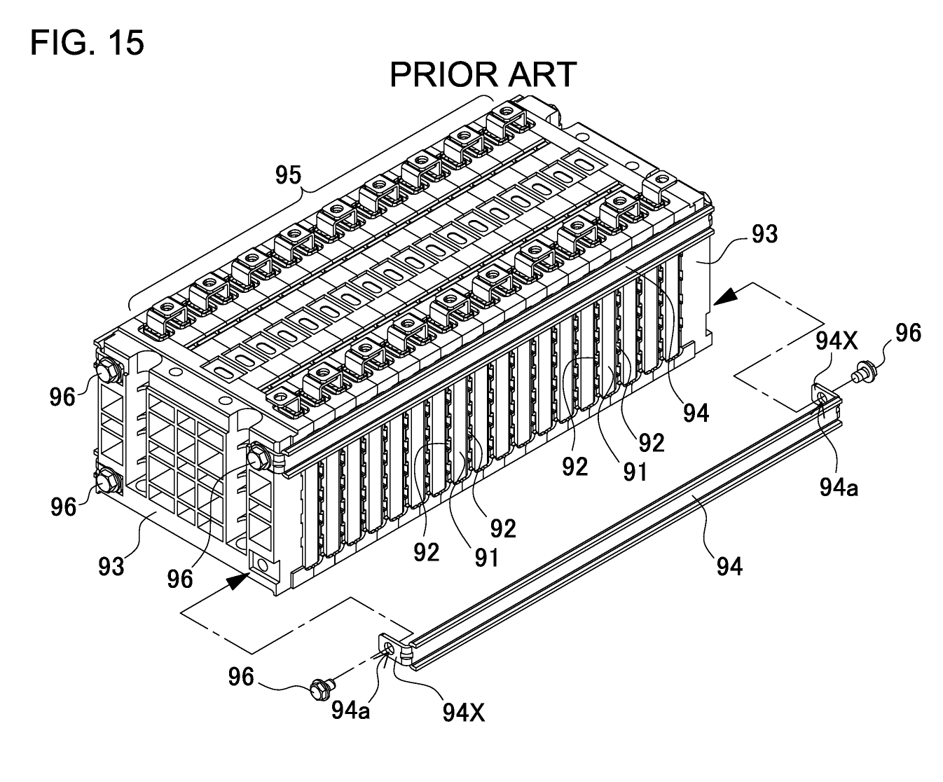

### DETAILED DESCRIPTION OF THE INVENTION

The following description will describe embodiments according to the present invention with reference to the drawings. It should be appreciated, however, that the embodiments described below are illustrations of a battery pack and a vehicle including this battery pack to give a concrete form to technical ideas of the invention, and a battery pack and a vehicle including this battery pack of the invention are not specifically limited to description below. Furthermore, it should be appreciated that the members shown in claims attached hereto are not specifically limited to members in the embodiments. Unless otherwise specified, any dimensions, materials, shapes and relative arrangements of the members described in the embodiments are given as an example and not as a limitation. Additionally, the sizes and the positional relationships of the members in each of drawings are occasionally shown larger exaggeratingly for ease of explanation. Members same as or similar to those of this invention are attached with the same designation and the same reference signs, and their description is omitted. In addition, a plurality of structural elements of the present invention may be configured as a single part that serves the purpose of a plurality of elements, on the other hand, a single structural element may be configured as a plurality of parts that serve the purpose of a single element. Also, the description of some of examples or embodiments may be applied to other examples, embodiments or the like.

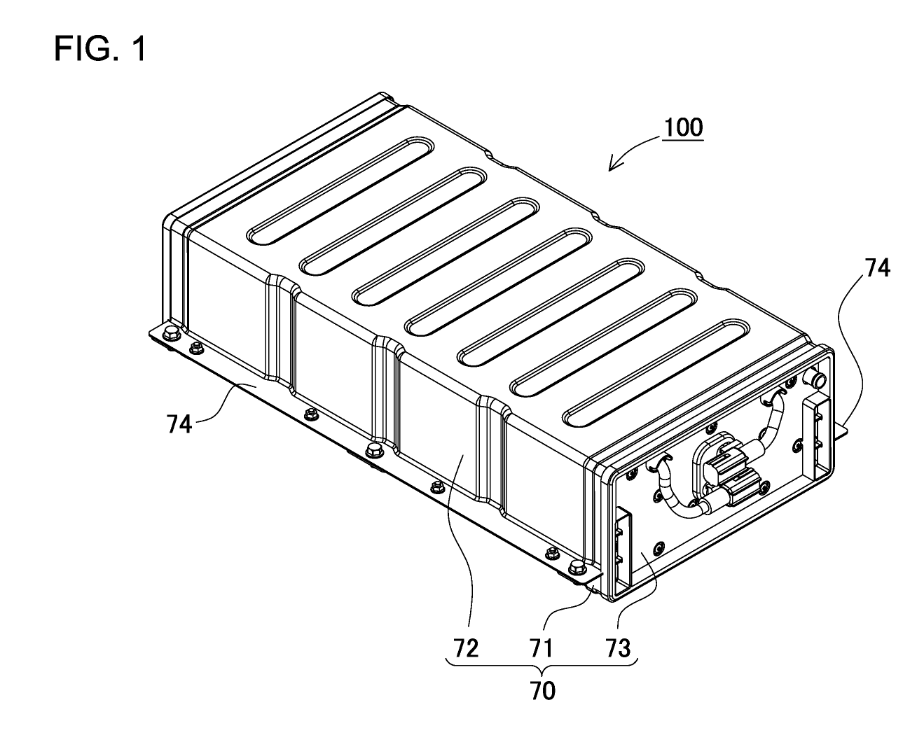

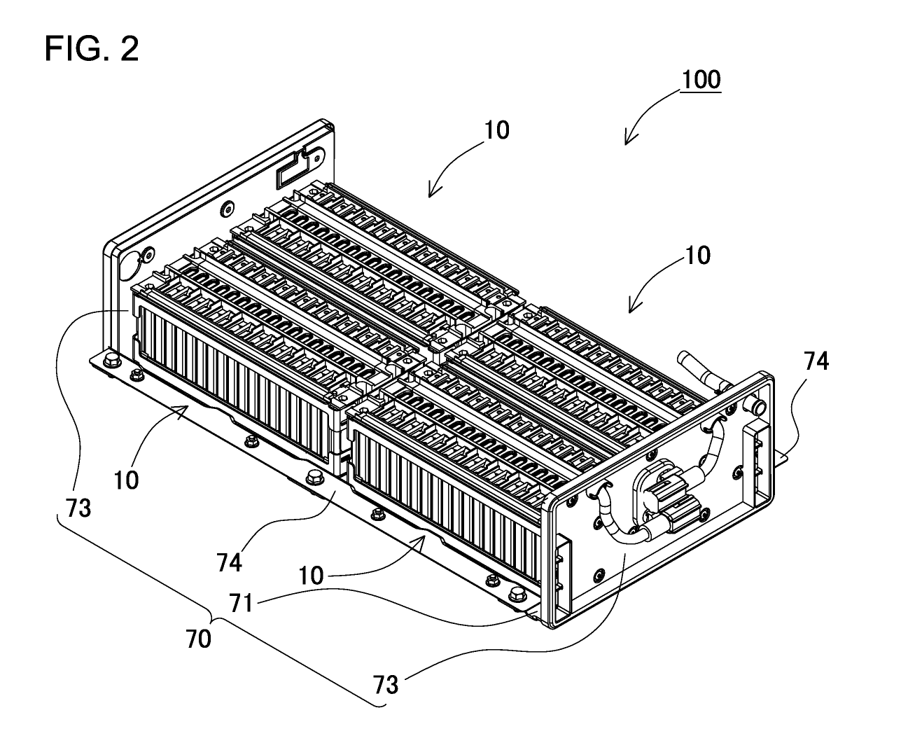

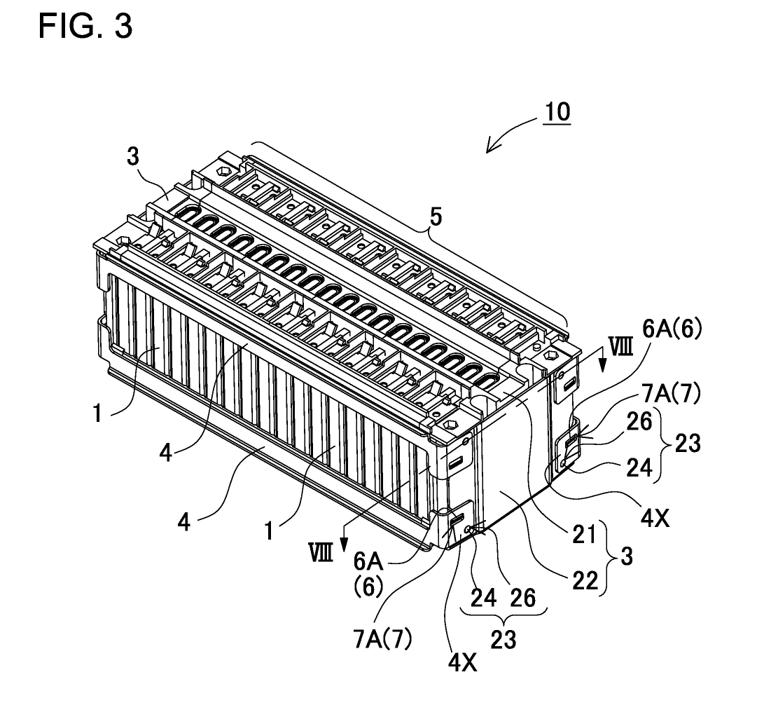

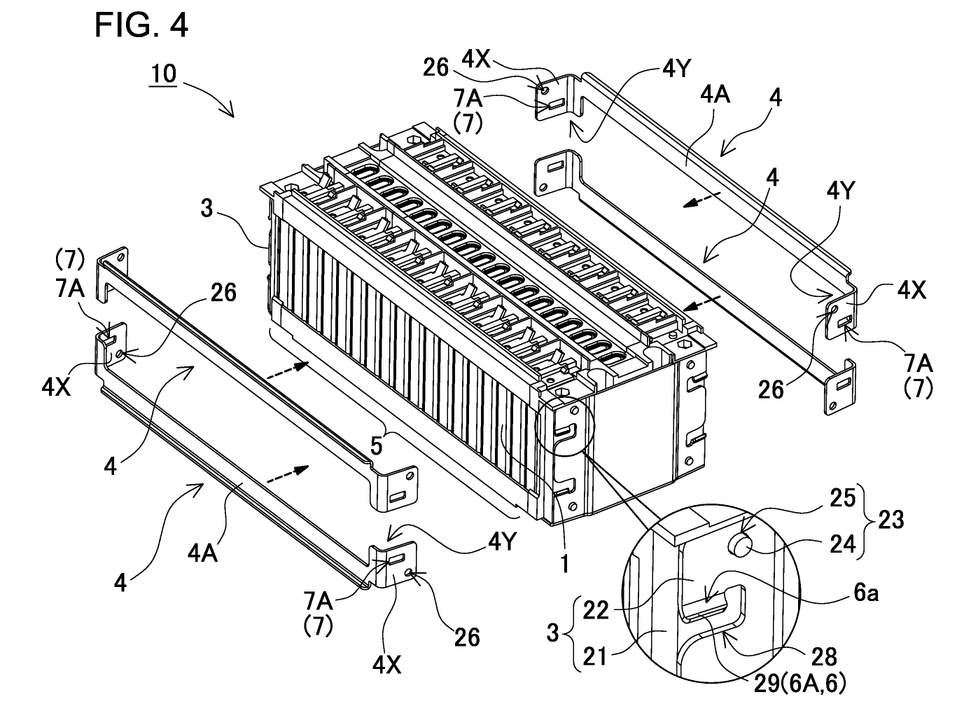

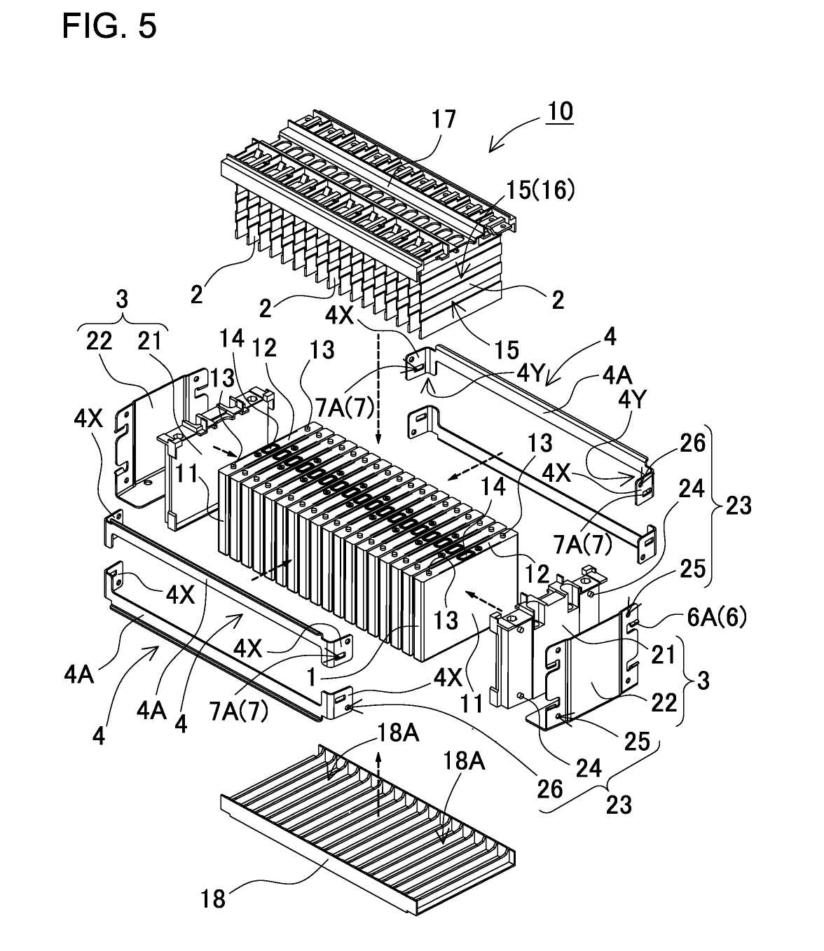

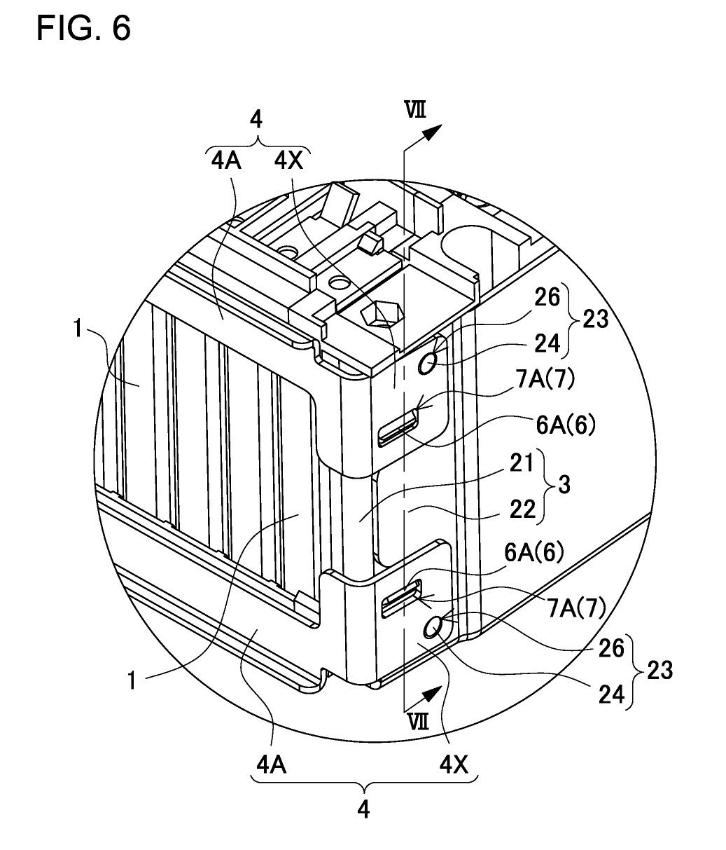

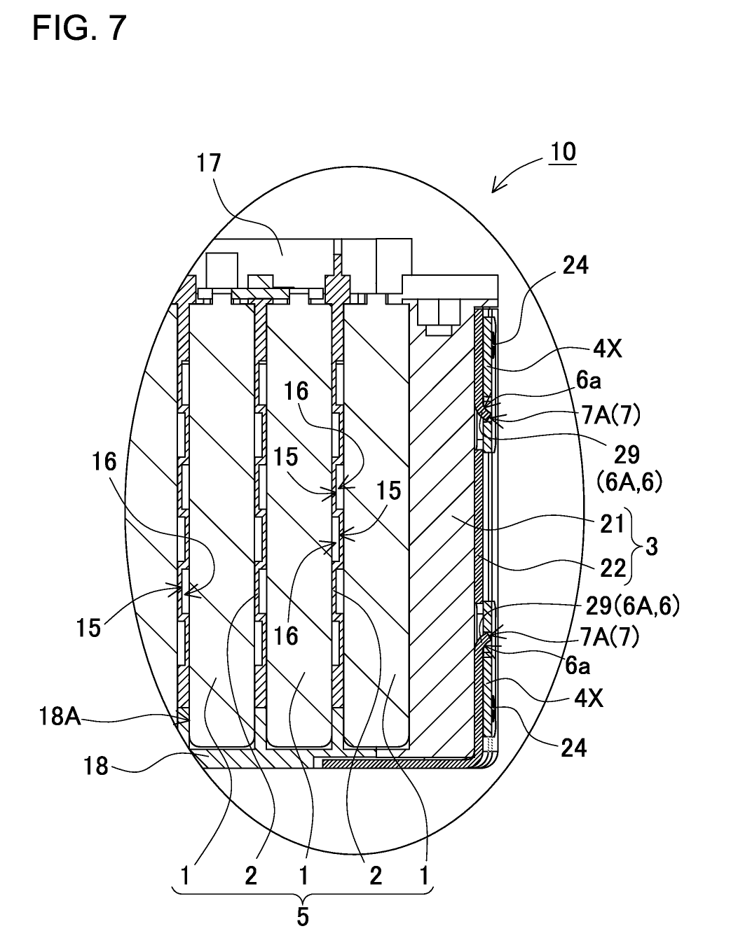

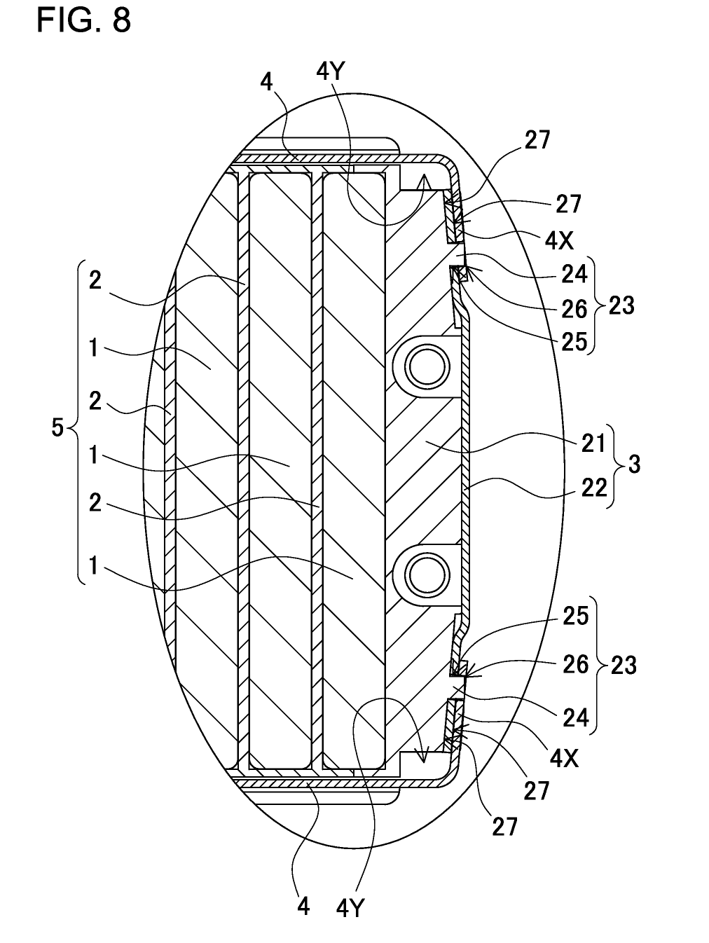

With reference to FIGS. 1 to 8, the following description will describe a battery pack according to a first embodiment included in a vehicle power supply device. FIG. 1 is an external view showing the power supply device. FIG. 2 is a perspective view showing the battery pack shown in FIG. 1 with an upper case being removed. FIG. 3 is an external view showing the battery pack. FIGS. 4 and 5 are exploded perspectives view showing the battery pack shown in FIG. 3. FIG. 6 is an enlarged perspective view showing the battery pack. FIGS. 7 and 8 are enlarged vertical and horizontal perspectives view showing the end part of the battery pack, respectively.

### (Power Supply Device 100)

As shown in the perspective view of FIG. 1, the power supply device 100 has a box external shape having a rectangular upper surface. The power supply device 100 has a box-shaped exterior case 70 that includes two case portions, and accommodates a plurality of battery packs 10 as shown in FIGS. 1 and 2. The exterior case 70 is constructed of a lower case portion 71, an upper case portion 72, and end surface plates 73. The end surface plates are coupled to the both ends of the lower and upper case portions 71 and 72. Each of the upper and lower case portions 72 and 71 has flange portions 74 that protrude outward. The flange portions 74 of the upper case portion 72 are secured to the flange portions 74 of the lower case portion 71 by bolts and nuts. The exterior case 70 shown in FIGS. 1 and 2 includes the flange portions 74, which are arranged along the side surfaces of the exterior case 70. As shown in FIG. 2, the lower case portion 71 accommodates four battery packs 10, which are arranged in two rows and two columns. The battery packs 10 are fastened to the lower case 71 by fastening screws, or the like, and secured in place inside the exterior case 70. The end surface plates 73 are coupled to the both ends of the lower and upper case portions 71 and 72 so that the both ends of the exterior case 70 are closed.

### (Battery Pack 10)

As shown in FIGS. 3 to 8, the battery pack 10 includes a plurality of rectangular battery cells 1, and electrically insulating separators 2, a pair of end plates 3, and a plurality of metal bind bars 4. The electrically insulating separators 2 are sandwiched between the plurality of rectangular battery cells 1, and electrically insulate the plurality of rectangular battery cells 1 from each other. The rectangular battery cells are arranged on the arrangement surfaces of each of the separators. The plurality of rectangular battery cells 1 and the separator 2 are alternately arranged side by side. The end plates are arranged on the side-by-side arrangement directional end surfaces of the battery assembly 5. The metal bind bars securely hold the end plates 3 on the both end surfaces of the battery assembly 5. The battery pack 10 includes the battery assembly 5. The battery assembly 5 is constructed of the side-by-side arranged rectangular battery cells 1, and the electrically-insulating separators 2. The electrically-insulating separators are sandwiched between the rectangular battery cells. The end plates 3 are arranged on both the end surfaces of this battery assembly 5. The end plates 3 are coupled to each other through the bind bars 4. In the illustrated battery pack, the separator 2 is sandwiched between the arrangement surfaces of the rectangular battery cells 1 whereby electrically insulating the adjacent rectangular battery cell 1 from each other. Thus, the rectangular battery cells 1 and the separators 2 are arranged alternately so that the battery assembly 5 is formed. However, the separators are not necessarily sandwiched between rectangular battery cells in the battery pack. In this case, in order to electrically insulate the adjacent rectangular battery cells from each other, an exterior case of the rectangular battery cell can be formed of an electrically insulating material. Alternatively, the peripheral parts of the exterior case of the rectangular battery cell can be covered by electrically-insulating sheets, electrically-insulating paint, or the like. In the case where the battery pack does not include the separators, which are sandwiched between the rectangular battery cells, instead of air-cooling systems that forcedly blow cooling air for cooling the rectangular battery cells to parts between the rectangular battery cells, the battery pack can be provided with a system that directly cools the rectangular battery cells by using coolant or the like for cooling the rectangular battery cells (so-called direct cooling system).

### (Rectangular Battery Cell 1)

The rectangular battery cell 11 is constructed of an exterior container 11 that has an exterior shape with a thickness smaller than its width as shown in FIG. 5. A sealing plate 12 closes an opening of the exterior container 11. The sealing plate includes positive/negative electrode terminals 13. A safety valve 14 is arranged between the electrode terminals 13. The safety valve 14 can open so that the internal gas can be discharged when the internal pressure of the exterior container 11 rises to a predetermined value. If the safety valve 14 opens, it is possible to prevent the pressure rise of the exterior container 11.

A base battery that composes the rectangular battery cell 1 is a rechargeable battery such as lithium ion battery, nickel metal hydride battery, and nickel-cadmium battery. In the case where lithium-ion batteries are used as the rectangular battery cells 1, it is possible to increase charge capacity density (per the entire volume or mass of the battery pack).

The rectangular battery cell 1 shown in FIG. 5 has a rectangular shape with a predetermined thickness, and includes the positive/negative electrode terminals 13 and an opening for the safety valve 14. The positive/negative electrode terminals protrude from the end parts of the upper surface of the battery cell. The opening is located in the middle part of the upper surface of the battery cell. The positive/negative electrode terminals 13 of the adjacent side-by-side-arranged rectangular battery cells 1 are serially connected to each other by the bus bars (not shown). Since the adjacent rectangular battery cells 1 of the battery pack 10 are serially connected to each other, the output voltage of the battery pack can be high. As a result, the battery pack can provide high electric power. It will be appreciated that the battery pack can include rectangular battery cells that are connected in parallel to adjacent battery cells.

The rectangular battery cell 1 includes the metal exterior container 11. The separators 2 formed of an electrically-insulating material are sandwiched between the rectangular battery cells 11. Accordingly, it is possible to prevent that a short circuit occurs between the exterior containers 11 of the adjacent rectangular battery cells. The exterior container of the rectangular battery cell may be formed of an electrically insulating material such as plastic. In this case, since the electrically-insulating exterior containers of the rectangular battery cells are not necessarily electrically insulated from each other when being arranged side by side, the separators may be formed of metal.

### (Separator 2)

The separators 2 electrically and thermally insulate adjacent rectangular battery cells 1 from each other when the rectangular battery cells are arranged side by side. The separators 2 are formed of an electrically insulating material such as plastic. The separator 2 is sandwiched between the adjacent rectangular battery cells 1 whereby electrically insulating the adjacent rectangular battery cells from each other. As shown in FIGS. 5 and 7, the separator 2 can have gas-flowing gaps 16 that are formed between the rectangular battery cells 1. Cooling gas such as air can pass through the gas-flowing gaps 4 to cool the rectangular battery cells 1. The illustrated separator 2 has grooves 15 on its surfaces that face the rectangular battery cells 1. The grooves extend between the both side edges of the separator. The gas-flowing gaps 16 are thus formed between the rectangular battery cells 1. In the illustrated separator 2, the grooves 15 are arranged in parallel to each other and spaced at a predetermined interval away from each other. The grooves 15 are formed on the both surfaces of the separator 2. Thus, the gas-flowing gaps 16 are formed between the separator 2 and the rectangular battery cells 1 adjacent to this separator. The thus-configured power supply device has a feature that the rectangular battery cells 1 on the both surface sides of the separator 2 can be effectively cooled by the gas-flowing gaps 16, which are formed on the both surface sides of the separator 2. However, the grooves may be formed only on one side of the separator. In this case, the gas-flowing gaps are formed between one rectangular battery cell and the separator. The illustrated gas-flowing gap 16 extends in the horizontal direction, and opens toward the left and right sides of the battery assembly 5. As discussed above, air is forcedly blown through the gas-flowing gaps 16, and efficiently and directly cools the exterior containers 11 of the rectangular battery cells 1. According to this construction, there is a feature in that thermal runaway of the rectangular battery cell 1 can be effectively prevented and the rectangular battery cells 1 can be efficiently cooled.

In the battery pack 10 shown in FIGS. 5 and 7, the upper and lower edge parts of the separators 2 are coupled to the upper and lower plate portions 17 and 18 and arranged in place with the separators being sandwiched between the rectangular battery cells 1. In the battery pack 10 shown in FIGS. 5 and 7, the upper edge parts of the separators 2 are fastened to the lower surface of the upper surface plate portion 17 and spaced at a predetermined interval away from each other so that the separators 2 are arranged in place in parallel to each other. The lower plate portion 18 has fit-in structures 18A in order to prevent that the adjacent rectangular battery cells 1 are deviated from the predetermined positions. The bottom parts of the rectangular battery cells 1 can be fit in the fit-in structures. However, the separators may be separately provided. Also, in this case, the separators can be sandwiched between the adjacent rectangular battery cells. This separator can have fit-in structures on the both surface sides of the separator in order to prevent that the adjacent rectangular battery cells 1 are deviated from the predetermined positions. The rectangular battery cells can be fit in the fit-in structures.

### (End Plate 3)

The pair of end plates 3 are arranged on the both end surfaces of the battery assembly 5 of the rectangular battery cells 1 and the separators 2, which are alternately arranged. When the pair of end plates 3 are firmly coupled to each other, the battery assembly 5 is securely held between the pair of end plates. The end plate 3 shown in FIG. 5 to FIG. 8 is constructed of a main plate 21, and a metal plate 22 that is arranged on the outside surface of the main plate. The main plate is formed of plastic by molding. The metal plate is formed of metal such as the aluminum. It will be appreciated that the end plate may be entirely formed of metal or plastic.

The metal plate 22 is coupled to the main plate 21, and arranged in a predetermined position on the main plate by a positioning mechanism 23. The positioning mechanism 23 shown in FIGS. 5 to 8 includes a positioning protruding parts 24, and positioning holes 25. The positioning protruding parts are arranged on the main plate 21. The positioning holes are arranged in the metal plate 22, and can receive the positioning protruding parts 24. The positioning protruding parts 24 are arranged in four corner areas on the outside surface of the illustrated main plate 21. The positioning protruding parts protrude toward the metal plate 22, which is arranged on the main plate, and are integrally with the main plate. In addition, the positioning holes 25 are formed in the four corner parts of the metal plate 22 that face the positioning protruding parts 24. The positioning protruding parts 24 can be inserted into the positioning holes. When the positioning protruding parts 24 on the four corner parts of the main plate 21 are guided into the positioning holes 25 in the four corner parts of the metal plate 22, the main plate 21 and the metal plate 22 are arranged in place in the end plate 3. The illustrated positioning protruding part 24 has a cylindrical shape, while the positioning hole 25 is a circular through hole into which the positioning protruding part 24 can be fit. The inner diameter of the positioning hole 25 is dimensioned substantially equal to or slightly larger than the outer diameter of the positioning protruding part 24 so that the positioning protruding part 24 can be held without deviation from its predetermined position.

In the positioning mechanism 23 shown in FIG. 5 to FIG. 8, the positioning protruding part 24 on the main plate 21 passes through the metal plate 22, and protrudes from the surface of the metal plate. The protruding positioning protruding part 24 engages with a bent part 4X of the bind bar 4. The bind bar 4 (discussed later in more detail) has coupling holes 26 in the bent parts 4X. The positioning protruding parts 24 can be guided into the coupling holes. When the positioning protruding parts 24 of the end plate 3 are guided into the coupling holes 26, the bind bar 4 can be positioned in place and coupled to the end plate 3. The inner diameter of the coupling hole 26 is also dimensioned substantially equal to or slightly larger than the outer diameter of the positioning protruding part 24 so that the positioning protruding part 24 can be held without deviation from its predetermined position. The thus-constructed positioning mechanism 23 can position the metal plate 22 in the predetermined position on the main plate 21 when the metal plate and the main plate are coupled to each other, and position the bind bar 4 in a predetermined position on the end plate 3 when the bind bar and the end plate are coupled to each other.

### (Bind Bar 4)

As shown in FIGS. 3 to 5, the bind bars 4 are arranged on the both side surfaces of the battery assembly 5 with the end plates 3 being arranged on the both end surfaces of the battery assembly 5. When the bind bars are fastened to the pair of end plates 3, the battery assembly 5 can be securely held. The bind bar 4 is a strip-shaped metal plate, which extends in the side-by-side arrangement direction of the battery assembly 5, and has a predetermined length extending along the surface of the battery assembly 5. In the illustrated battery pack 10, the strip-shaped bind bars 4 are arranged and spaced away from each other in the vertical direction on the side surface of the battery assembly 5. That is, in the battery pack 10, two bind bars 4 are arranged on each of the side surfaces of the battery assembly 5 to securely hold the battery assembly 5. Thus, total four bind bars 4 securely hold the left and right side surfaces of the battery assembly 5. According to the illustrated battery pack 10, since the two bind bars arranged on the upper and lower side parts of the side surface of the battery assembly 5, the central part of the side surface of the battery assembly 5 can be exposed. As a result, cooling air can flow through parts between the battery cells, and cool the battery cells. It will be appreciated that the bind bars may be arranged on the top and bottom surfaces of the battery assembly. In this battery pack, since the side surfaces of the battery assembly can be entirely opened, cooling air can more efficiently pass through parts between the battery cells.

The bind bar 4 includes the bent parts 4X, which are formed by bending the both end parts of a metal bar substantially at a right angle, so that the bind bar is formed in a substantially rectangular U shape as viewed from the bar edge side. The bind bar 4 is fit onto the side surface side of the battery assembly 5 with the end plates 3 arranged on the end surfaces of the battery assembly so that a substantially rectangular U-shaped opening 4Y of the bind bar receives the battery assembly and the end plates. Thus, the bent parts 4X on the both ends of the bind bar are coupled to the end plates 3 so that the battery assembly 5 is interposed and secured between the end plates 3. In order that the bind bar 4 can be fit onto the side surface side of the battery assembly 5 with the end plates 3 arranged on the end surfaces of the battery assembly so that the substantially rectangular U-shaped opening 4Y of the bind bar can receive the battery assembly and the end plates, the length of the strip-shaped main part 4A is dimensioned substantially equal to the overall length of the side surfaces of the battery assembly 5 and the end plates 3, which are arranged on the end surfaces. The end plate 3 shown in FIG. 8 includes an inclined surface 27 on a side part of the outside surface that is located on the engagement side where the substantially rectangular U-shaped opening 4Y of the bind bar 4 is held. The inclined surface descends toward the substantially rectangular U-shaped opening 4Y. According to this construction, when the bind bar 4 engages with the side surfaces of the battery assembly 5 and the end plates 3, which are arranged on the end surfaces of the battery assembly, the end plates and the battery assembly can be easily inserted into the substantially rectangular U-shaped opening 4 of the bind bar 4.

The height of the bent parts 4X shown in FIGS. 3 to 5, which are located on the both ends of the bind bar 4, is dimensioned larger than the strip-shaped main part 4A of the bind bar. According to this bind bar, since the engagement part of the bind bar can be large, the mechanical strength of the engagement part can be increased. However, the height of the bent parts of the bind bar, which are located on the both ends of the bind bar, is not necessarily dimensioned larger than the strip-shaped main part of the bind bar 34. The height of the bent parts of a bind bar 34, which are located on the both ends of the bind bar, can be dimensioned equal to a strip-shaped main part 34A of the bind bar. In a battery pack 30 shown in this figure, the weight of the bind bar 34 can be reduced.

### (Engagement Structure)

The aforementioned bind bar 4 is coupled to the end plate 3 by the engagement structure as discussed below. A bent-part-side engagement structure 7 is formed in the contact part of the bent part 4X of the bind bar 4 to be in contact with the outside surface of the end plate 3. An end-plate-side engagement structure 6 is positioned in the end plate 3 so as to face the bent part 4X of the bind bar 4. The bent-part-side and end-plate-side engagement structures 7 and 6 are positioned so as to face each other. When the bent-part-side and end-plate-side engagement structures 7 and 6 engage with each other, the pair of end plates 3 are fastened to the bind bar 4.

In the battery pack 10 shown in FIGS. 3 to 7, the bent-part-side engagement structure 7 is a slit 7A that is formed in the bent part 4X in a rectangular shape, while the end-plate-side engagement structure 6 is an engagement protrusion 6A that can be inserted into the slit 7A. The bent part 4X shown in FIGS. 3 to 6 has the slit 7A, which are formed in a rectangular shape extending in the horizontal direction in the figures. The bind bars 4 are arranged on upper and lower parts of the side surface of the battery assembly 5 as shown in the figures. The bent parts 4X of the bind bar have a large height. The slits 7A are formed in positions of the bent parts that face each other and are arranged close to the central parts of the bent parts. The engagement protrusion 6A of the end plate 3 is a bent part 29 that is partially formed by bending the metal plate 22. The engagement protrusion 6A constructed of the bent part 29 of the metal plate 22 has a width and a protruding amount that can be fitted into the slit 7A formed in the bent part 4X. As shown in a partially enlarged view of FIG. 4, the metal plate 22 has L-shaped cutouts 28 on the both side parts. The engagement protrusion 6A is formed by bending an enclosed part of the metal plate that is enclosed by the L-shaped cutout 28 in the horizontal direction. In the thus-constructed engagement protrusion 6A, the width and the protruding amount of the bent portion 29 as the engagement protrusion 6A can be adjusted by the horizontal length and the vertical length of the L-shaped cutout 28 in the metal plate 22. In the case where the bent part 29 as the engagement protrusion 6A constructed of the bent part 29 of the metal plate 22 has a large width and a large protruding amount, the bent part can have high strength against the force applied to the bent part when the bent part is pulled through the bind bar 4. From this viewpoint, the width and the protruding amount of the bent part 29 as the engagement protrusion 6A are adjusted to the optimal dimensions in consideration of the pulling force from the bind bar 4.

An inclined surface 6a is formed on one side of the engagement protrusion 6A shown in FIGS. 4 and 7. That is, the engagement protrusion 6A constructed of the bent part 29 of the metal plate 22 includes the inclined surface 6a, which is formed by bending the metal plate at the boundary between the main section of the metal plate 22 and the enclosed part so that this bent part ascends toward the end of the engagement protrusion from the main section of the metal plate and serves as the inclined surface 6a. According to the thus-constructed engagement protrusion 6A, since the bent part 4X can slide on the inclined surface 6a, the bent part can be easily inserted into the slit 7A. However, the engagement protrusion constructed of the bent part of the metal plate may not include the inclined surface but be bent at a right angle. On the other hand, the engagement protrusion may include an inclined surface that ascends along an insertion direction of the bent part. In this case, the bent part can be smoothly inserted along this inclined surface of the engagement protrusion.

The illustrated bind bar 4 includes the coupling holes 26, which position the positioning protruding parts 24 in place in the bent parts 4X. In the illustrated bind bar 4, the coupling hole 26 is formed in the end part of the bent part 4X, and spaced away from the slit 7A. According to this bind bar 4, when the positioning protruding part 24 is inserted into the coupling hole 26 as the positioning mechanism 23, the end plate 3 and the bent part 4X can be reliably coupled to each other with the bent part 4X being arranged in the predetermined position of the end plate 3. In other words, since the coupling hole 26 is spaced away from the slit 7A, after the end plate 3 and the bent part 4X are coupled to each other by the slit 7A as the bent-part-side engagement structure 7 and the engagement protrusion 6A as the end-plate-side engagement structure 6, it is possible to surely prevent positional deviation such as rotation and wobble, and to stably hold the end plate and the bent part. That is, this bent part 4X can be firmly coupled to the end plate 3 by the engagement structure of the slit 7A as the bent-part-side engagement structure 7 and the engagement protrusion 6A as the end-plate-side engagement structure 6, while the fit-in engagement of the positioning mechanisms 23 between the positioning protruding part 24 and the coupling hole 26 can surely prevent positional deviation such as rotation and wobble, and stably hold the end plate and the bent part.

In the illustrated battery pack 10, the end plate 3 and the bent part 4X are coupled to each other by one pair of the bent-part-side and end-plate-side engagement structures 7 and 6. However, the end plate and the bent part can be coupled to each other by two or more pairs of bent-part-side engagement structures and end-plate-side engagement structures. In this case, since the bent part can be coupled to the end plate at two or more positions by two or more pairs of bent-part-side and end-plate-side engagement structures, there is a feature that the bent part can be coupled to the end plate without positional deviation.

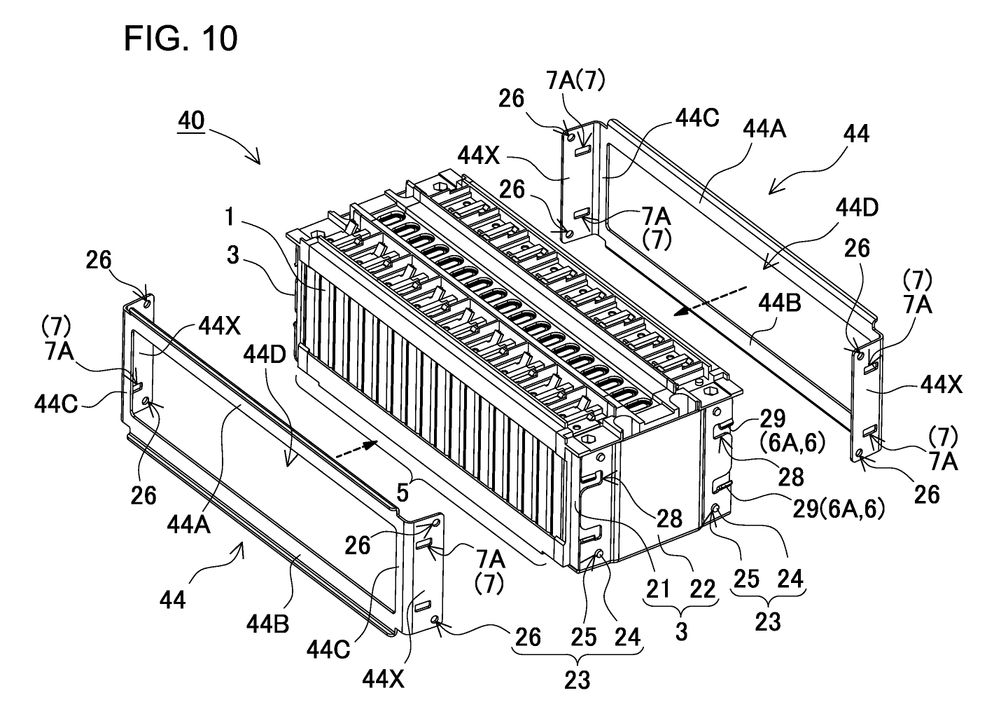

In the aforementioned battery pack 10, the two bind bars 4 are arranged on the upper and lower parts of each side surface of the battery assembly 5, and spaced away from each other in the vertical direction. However, the battery pack can include the bind bars each of which is constructed of bar portions that are arranged on the upper and lower parts of the side surface of the battery assembly 5 and integrally formed. In a bind bar 44 shown in FIG. 10 includes upper and lower bar portions 44A and 44B, and coupling portions 44C. The upper and lower bar portions are arranged on the upper and lower end parts of the side surface of the battery assembly 5. The ends of the upper bar portion are integrally coupled to the ends of the lower bar portion by the coupling portions 44C. The coupling portions are secured to the end plates 3. That is, the upper and lower bar portions 44A and 44B cover the upper and lower parts of the side surface of the battery assembly 5 so that the illustrated bind bar 44 has an opening 44D that exposes the central part of the side surface of the battery assembly. According to this battery pack 10, since the central part of the side surface of the battery assembly 5 can be exposed through the opening 44D, which is formed in the central part of the bind bar 44, cooling air can flow through parts between the battery cells 1 from the opening 44D.

### MODIFIED EMBODIMENT

In the bind bar 44 shown in FIG. 10, the coupling portions 44C on the both ends are bent inward so that each of the coupling portions fits with the outer peripheral surface and the end surface of the end plate 3, and serves as the bent part 44X. The bent parts 44X are coupled to the end plates 3 by the engagement structures. The bent parts 44X on the both ends include the slits 7A as the bent-part-side engagement structures 7, which are formed in a rectangular shape similar to the aforementioned bind bar 4. The illustrated bent part 44X has a pair of slits 7A that are positioned so as to receive the engagement protrusions 6A as a pair of bent parts 29 that are arranged on each of the both side parts of the metal plate 22 of the end plate 3. The slits are formed in parallel to each other. This bind bar has a feature that the bind bar can be positioned in the predetermined position on the end plate without positional deviation when the pair of engagement protrusions 6A are fitted into the pair of slits 7A. The illustrated bent part 44 includes the coupling holes 26, which position the positioning protruding parts 24 of the end plate 3 in place. According to this construction, the bind bar 44 can be accurately positioned in the predetermined position. The bind bar 44 can be manufactured by cutting and then stamping a metal plate of iron or iron alloy.

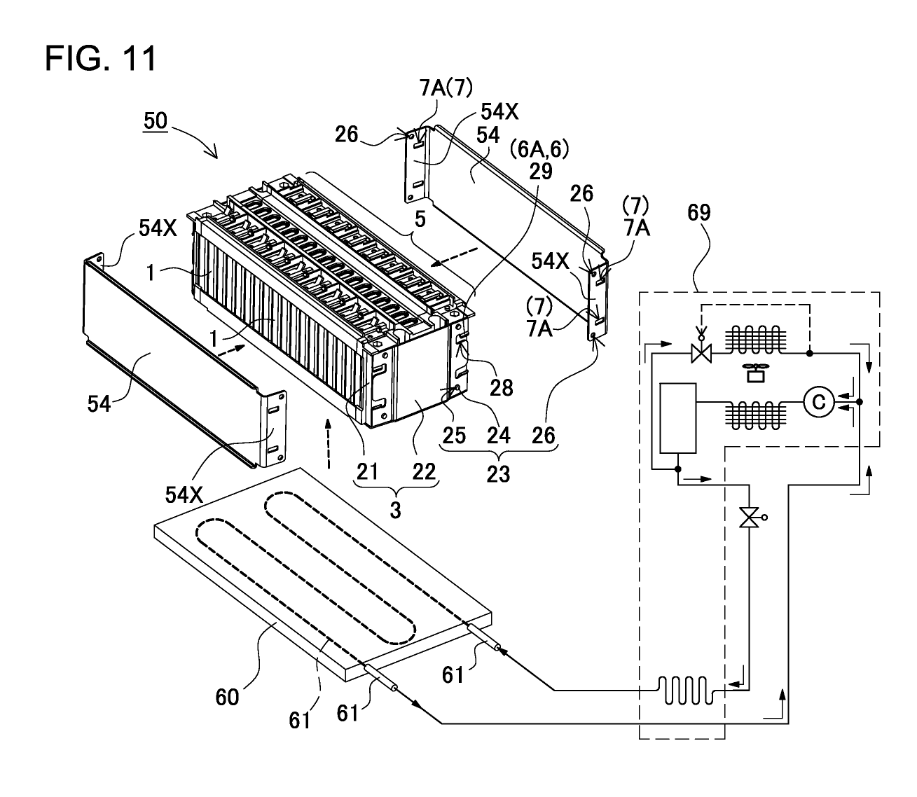

In the foregoing embodiment, an air-cooling system is used which forcedly blows cooling air for cooling the rectangular battery cells 1 to parts between the rectangular battery cells. However, the present invention is not limited to air-cooling systems. So-called direct cooling systems can be used which directly cool the rectangular battery cells by using coolant or the like for cooling the rectangular battery cells. The following description will describe an exemplary battery pack according to a modified embodiment, which uses a direct cooling system with reference to FIG. 11.

The battery assembly 5 includes a plurality of rectangular battery cells 1, which are arranged side by side in the battery pack 50 shown in FIG. 11. The battery assembly 5 is arranged on the upper surface of a cooling plate 60. This cooling plate 60 is thermally connected to the rectangular battery cells 1 of the battery assembly 5. The cooling plates 60 include a coolant pipe 61. The coolant pipe 61 is connected to a cooling mechanism 69. In this battery pack 50, the battery assembly 5 is in contact with the cooling plate 60, and can be directly and effectively cooled by the cooling plate. The cooling plate may cool not only the battery assembly but also members that are arranged on end surfaces of the battery assembly, and the like, for example.

In the battery pack 50 shown in FIG. 11, since the rectangular battery cells 1 can be cooled through the cooling plate 60, a bind bar 54 is formed in a plate shape that is dimensioned to cover the side surface of the battery assembly 5. The bind bar 54 includes bent parts 54X that is formed by bending the both end parts of the plate-shaped metal plate. The bent part 54X is coupled to the side surface of the end plate 3. Since the bind bar 54 can hold the entire side surface of the battery assembly 5, the bind bar can more firmly hold the pair of end plates and the battery assembly together. It will be appreciated that, also in the battery pack that includes the cooling plate, the battery assembly and the pair of end plates can be held by the bind bars according to the foregoing embodiments.

### (Cooling Plate 60)

The cooling plate 60 is a cooling member for transferring heat from the rectangular battery cells 1 to the outside. In the illustrated battery pack, the coolant pipe 61 is arranged inside the cooling plate. The cooling plate 60 includes the cooling pipe 61 as heat exchanger, which is the coolant pipe formed of copper, aluminum, or the like. Liquefied coolant as cooling fluid circulates through the cooling pipe. The cooling pipe is thermally connected to an upper plate portion (not shown) of the cooling plate 60. A thermally insulating material is arranged between the cooling pipe and a bottom plate portion (not shown) of the cooling plate so that the cooling pipe is thermally insulated from the bottom plate portion. Thus, the cooling plate 60 has the cooling feature. However, the cooling plate may be composed of only a metal plate. For example, the cooling plate may be a metal plate, or the like, which has radiating fins or other shapes with high heat dissipating or transferring effects. The cooling plate according to the present invention is not limited to metal plate. The cooling plate may include an electrically insulating but thermally conductive sheet.

The cooling fluid is provided from the cooling mechanism 69 to the coolant pipe 61, which extends inside the cooling plate, so that the cooling plate 60 is cooled. When the cooling fluid as the coolant is provided from the cooling mechanism 69 to the cooling plate 60, the cooling fluid can be evaporated inside the coolant pipe 61 so that the cooling plate 60 can be efficiently cooled by the heat of evaporation.

In addition, the cooling plate 60 serves as a means for reducing unevenness of temperatures of the plurality of rectangular battery cells 1. That is, the cooling plate 60 can be adjusted to absorb heat energy from the rectangular battery cells 1 so that the cooling plate 61 cools high temperature rectangular battery cells (e.g., rectangular battery cell in the central area) by a relatively large degree, while the cooling plate 61 cools low temperature rectangular battery cells (e.g., rectangular battery cells in the both end areas) by a relatively small degree. Thus, the cooling plate can reduce temperature difference between the rectangular battery cells. As a result, it is possible to reduce unevenness of temperatures of the rectangular battery cells. Therefore, it is possible to prevent that some of the rectangular battery cells deteriorate relatively larger, and are brought into an overcharged or over-discharged state.

Although the cooling plate 60 is arranged on the bottom surface of the battery assembly 5 in the battery pack shown in FIG. 11, the present invention is not limited to this. For example, the cooling plate may be arranged on the side surfaces of the battery cells.

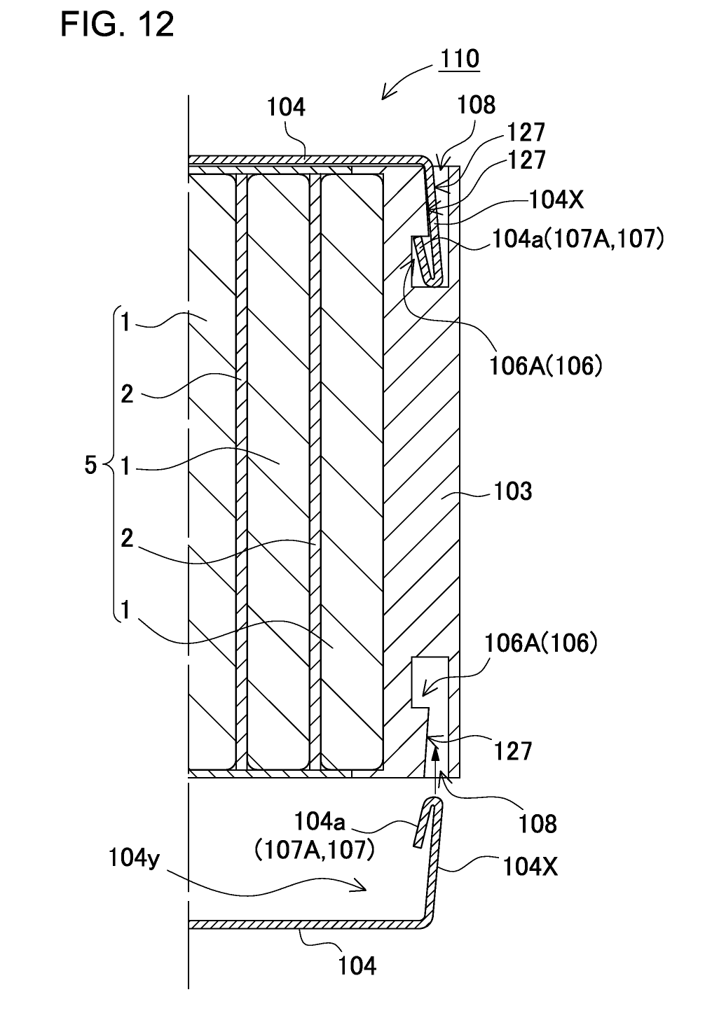

In the aforementioned battery packs, the bent parts 4X, 34X, 44X or 54X on the both ends of the bind bar 4, 34, 44 or 54 are fit onto the side surfaces of the end plates 3 so that the bind bar 4, 34, 44 or 54 are fastened to the end plates 3. That is, the bent parts 4X, 34X, 44X or 54X on the both ends of the bind bar 4, 34, 44 or 54 are coupled to the side surfaces of the pair of end plates 4, 34, 44 or 54 with the bent parts being in press contact with the end plates. However, the bind bar is not always required to be in contact with the side surfaces of the end plates. It will be appreciated that the bind bar can engage with recessed parts of end plates 103, as shown in FIG. 12.

Slit-shaped deep recessed insertion parts 108 are formed on the both side surfaces of the illustrated end plate 103. The bent parts 104X of the bind bar 104 can be inserted into the insertion parts. The insertion parts 108 serve as coupling parts for receiving the bind bar 104. The opening height (the vertical length) of the insertion part 108 of the end plate 103 is dimensioned substantially equal to the height of the bent part 104X. The horizontal width (the width in the side-by-side arrangement direction of the rectangular battery cells) of the insertion part 108 is dimensioned so as to receive the end of the bent part 104X. The illustrated bind bar 104 includes interlocking protruding parts 107A in the ends of the bent part 104X. The interlocking protruding parts serve as engagement structures 107. A bent end 104a is formed by folding the end part of the illustrated bent part 104X at an obtuse angle (preferably 135 to 180 degrees). The bent end 104a serves as the interlocking protruding part 107A. The end plate 103 includes interlocking parts 106A that are arranged inside the insertion parts 108. The interlocking parts are positioned so as to face the bent ends 104a of the bent parts 104X when the bent parts are inserted into the insertion parts 108. Thus, the interlocking part can interlock with the interlocking protruding parts 107A when the interlocking protruding parts are inserted into the insertion parts. The illustrated interlocking part 106 is a recessed part that can receive the entire bent end 104a and interlock with the end edge of the bent end 104a. It will be appreciated that the interlocking part can be a through hole or an interlocking groove. In the battery pack 110 shown in FIG. 12, when the bent parts 104X of the bind bar 104 are inserted in the insertion parts 108 of the end plates 103, the interlocking protruding parts 107A as the bent-part-side engagement structures 107 in the bent parts 104X interlock with the interlocking parts 106A as the end-plate-side engagement structures 106, which are arranged inside the insertion part 108. Thus, the bent parts 104X are fastened to the end plates 103 not to be detached from the insertion part 108.

The illustrated end plate 103 includes an inclined surface 127 on a side part that is located on an interior wall of the insertion part 108 on the engagement side where a substantially rectangular U-shaped opening 104Y of the bind bar 104 is held. The inclined surface descends toward the substantially rectangular U-shaped opening 104Y. According to this construction, when the bind bar 104 engages with the side surfaces of the battery assembly 5 and the end plates 103, which are arranged on the end surfaces of the battery assembly, the end plates and the battery assembly can be easily inserted into the substantially rectangular U-shaped opening 104Y of the bind bar 104.

In the battery pack 110 shown in FIG. 12, the bent-part-side engagement structure 107 is constructed as the interlocking protruding part 107A, which is provided in the bent part 104X, while the end-plate-side engagement structure 106 is constructed as the interlocking part 106A, which is constructed of the recessed part or through hole formed in the insertion part 108. However, in the battery pack, the bent-part-side engagement structure can be an interlocking part that is constructed of the recessed part or through hole, while the end-plate-side engagement structure can be an interlocking protruding part that protrudes from the interior wall of the insertion part.

### (Vehicles Including Battery Pack)

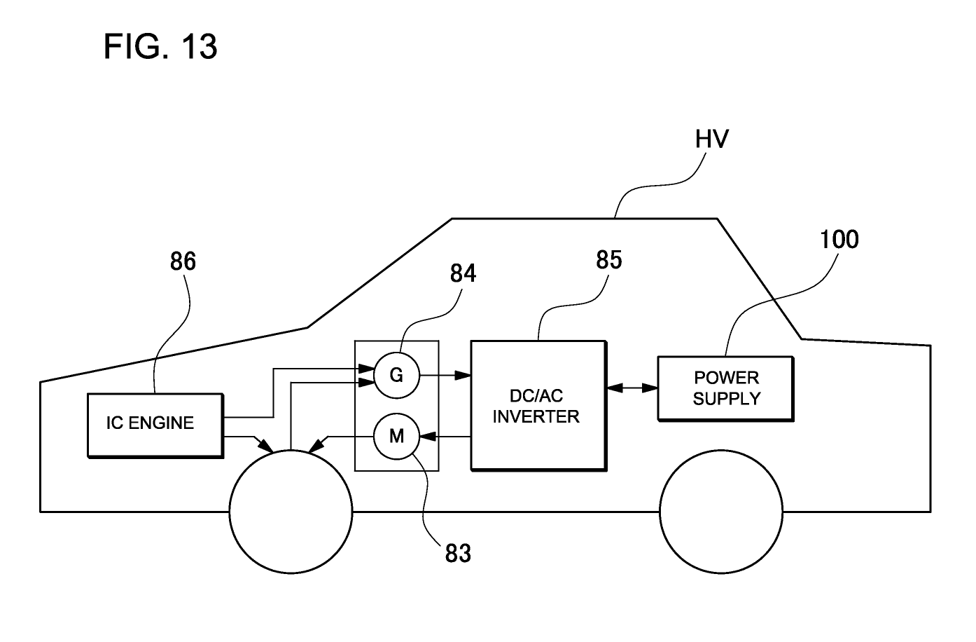

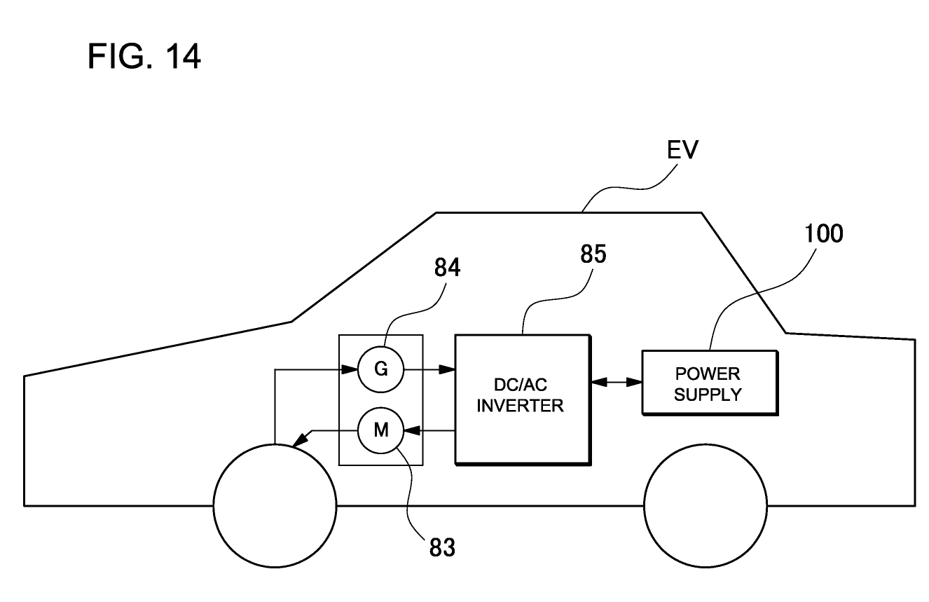

With reference to FIGS. 13 and 14, a vehicle is now described which includes the power supply device using the aforementioned battery pack. FIG. 13 shows a hybrid car HV as the vehicle that includes the power supply device, and is driven both by an internal-combustion engine and an electric motor. The illustrated hybrid car includes an internal-combustion engine 86, an electric motor 83, a power supply device 100, and an electric generator 84. The internal-combustion engine and the electric motor drive the vehicle. The power supply device supplies electric power to the electric motor 83. The electric generator 84 charges the rectangular battery cells of the power supply device 100. The power supply device 100 is connected to the electric motor 83 and the electric generator 84 via a DC/AC inverter 85. The hybrid car HV is driven both by the electric motor 83 and the internal-combustion engine 86 with the rectangular battery cells of the power supply device 100 being charged/discharged. The electric motor 83 is energized and drives the vehicle in a poor engine efficiency range, e.g., in acceleration or in a low speed range. The electric motor 83 is energized by electric power that is supplied from the power supply device 100. The electric generator 84 is driven by the engine 86 or by regenerative braking during vehicle braking so that the rectangular battery cells of the power supply device 100 are charged.

FIG. 14 shows an electric car EV as the vehicle that includes the power supply device, and is driven only by the electric motor. The illustrated electric car

EV includes the electric motor 83 that drives the vehicle EV, the power supply device 100 that supplies electric power to the electric motor 83, and the electric generator 84 that charges batteries of the power supply device 100. The power supply device 100 is connected to the electric motor 83 and the electric generator 84 via the DC/AC inverter 85. The electric motor 83 is energized by electric power that is supplied from the power supply device 100. The electric generator 84 can be driven by vehicle regenerative braking so that the rectangular battery cells 20 of the power supply device 100 are charged.

A battery pack and a vehicle including the battery pack according to the present invention can be suitably used as vehicle power source for electric cars or hybrid cars. Also, a battery pack according to the present invention can be suitably used as power supply devices for applications other than vehicle power supply device.

1. A battery pack comprising:
a battery assembly including a plurality of rectangular battery cells that are arranged side by side;
a pair of end plates that are arranged on the side-by-side arrangement directional end surfaces of the battery assembly; and
a plurality of metal bind bars that couple said end plates, which are arranged on the end surfaces of said battery assembly, to each other,
wherein each of the bind bars includes bent parts that are formed by bending the both end parts of the bind bar toward a common direction, and the bind bar is formed in a substantially rectangular U shape as viewed from the bar edge side by forming the bent parts by bending the both end parts of the bind bar, wherein the bent parts on the both ends of the bind bar are coupled to said end plates so that said battery assembly is interposed and secured between the end plates,
wherein said bent part includes a bent-part-side engagement structure in a coupling area of the bent part to be coupled to said end plate,
wherein said end plate includes an end-plate-side engagement structure that is positioned so as to face said bent part, and
wherein said end plates are securely held by the bind bars when said bent-part-side engagement structures of the bind bars engage with the end-plate-side engagement structures of the end plates.

2. The battery pack according to claim 1, wherein said bind bar is constructed so that the bent parts on both ends of said bind bar can be in press contact with the outside surfaces of said end plates.

3. The battery pack according to claim 1, wherein said bent-part-side engagement structure is a slit that is formed in a rectangular shape, and said end-plate-side engagement structure is an engagement protrusion that can be inserted into said slit.

4. The battery pack according to claim 3, wherein said end plate includes a metal plate, wherein the metal plate is partially bent so that said engagement protrusion is formed.

5. The battery pack according to claim 3, wherein an inclined surface is formed on one side of said engagement protrusion.

6. The battery pack according to claim 1, wherein said end plate includes an inclined surface on a side part of the outside surface that is located on the engagement side where the substantially rectangular U-shaped opening of said bind bar is coupled, wherein the inclined surface descends toward the substantially rectangular U-shaped opening.

7. The battery pack according to claim 1, wherein said end plate includes a main plate that is formed of plastic, and a metal plate that is arranged on the outside surface of the main plate, wherein said metal plate is coupled to said main plate and arranged in a predetermined position on the main plate by a positioning mechanism, and the bent part of said bind bar is arranged in a predetermined position on said end plate by said positioning mechanism.

8. The battery pack according to claim 7, wherein said positioning mechanism includes a positioning protruding part that is arranged on said main plate, a positioning hole that is arranged in said metal plate, and can receive said positioning protruding part, and a coupling hole that is arranged in the bent part of said bind bar and can receive said positioning protruding part, wherein the positioning protruding part of said main plate is inserted into the positioning hole of said metal plate so that said metal plate is coupled to said main plate and arranged in the predetermined position on the main plate, and wherein the positioning protruding part that is inserted into said metal plate is inserted into the coupling hole of said bent part so that said bind bar is arranged in the predetermined position on said end plate.

9. The battery pack according to claim 1, wherein said bind bars are arranged on the side surfaces of said battery assembly.

10. The battery pack according to claim 9, wherein a plurality of strip-shaped bars are arranged as said bind bars and spaced away from each other in the vertical direction on the side surface of said battery assembly.

11. The battery pack according to claim 10, wherein the height of said bent parts, which are located on the both ends of the bind bar, is larger than the strip-shaped main part of the bind bar.

12. The battery pack according to claim 9, wherein upper and lower bar portions as said strip-shaped bars cover the upper and lower parts of the side surface of said battery assembly, wherein the both ends of said upper bar portion are coupled to the both ends of said lower bar portion so that said bind bar has an opening that exposes the central part of the side surface of said battery assembly.

13. The battery pack according to claim 9, wherein said bind bar is dimensioned to cover the side surface of said battery assembly, wherein said battery assembly is placed on the upper surface of a cooling plate, wherein said cooling plate includes a coolant pipe and is thermally connected to the bottom surfaces of said rectangular battery cells.

14. A vehicle comprising the battery pack according to claim 1.
